(19) United States
(12) Patent Application Publication
(10) Pub. No.: US 2010/0042446 A1
(43) Pub. Date: Feb. 18, 2010

(54) SYSTEMS AND METHODS FOR PROVIDING CORE PROPERTY REVIEW

(75) Inventors: Guy H. Volz, Matthews, NC (US); Mark C. Holoman, Charlotte, NC (US); Robert G. Becker, Charlotte, NC (US); Jacob P. Maliel, Quincy, MA (US)

Correspondence Address: Weiss & Arons, LLP, 1540 Route 202, Suite 8, Pomona, NY, 10970, US

(73) Assignee: Bank of America, Charlotte, NC (US)

(21) Appl. No.: 12/189,940

(22) Filed: Aug. 12, 2008

(51) Int. Cl. G06Q 10/00; G06Q 40/00

(52) U.S. Cl. 705/7; 705/36 R

(57) ABSTRACT

An apparatus for providing real estate property review and evaluation is provided. The apparatus may include a storage module, an analysis engine in communication with the storage module, and an evaluation output module in communication with the analysis engine. The analysis engine may be configured to receive from the storage module information corresponding to a plurality of real estate properties. The information may further correspond to a predetermined group of data points for each of the properties. The analysis engine may calculate a score for each of the properties based on the information for the data points for each of the properties. The analysis engine may also transmit to the evaluation output module an index value for each of the properties based, at least in part, on the calculated score for each of the properties.

### FIELD OF TECHNOLOGY

Aspects of the disclosure relate to evaluating real estate.

### BACKGROUND

Research has shown that, with respect to certain business entities, an indication that a real estate property is important to an entity may correspond to a lower vacancy rate for the property. Because real property assets sold when fully leased can deliver 30%-50% more in sales proceeds than vacant real estate assets, the development of an indicator that evaluates the strategic importance of a real estate asset to an entity may potentially maximize sales price in the event of a sale. Furthermore, such an indicator may influence asset utilization strategies.

It would be desirable, therefore, to provide systems and methods that evaluate the strategic importance of a real estate property.

### SUMMARY OF THE INVENTION

It is an object of this invention to provide systems and methods that evaluate the strategic importance of a real estate property.

A method for reviewing a plurality of real estate properties is provided. The plurality of real estate properties may be either owned in whole or in part or leased in whole or in part by a single entity.

The method may include extracting data from a database. The data may correspond to the plurality of real estate properties. The method may also include scoring each of the plurality of real estate properties based on an analysis of predetermined elements. The method may further include using a spreadsheet to perform a Net Present Value (“NPV”) analysis for each of the plurality of real estate properties. The method may include determining whether one or more of the plurality of real estate properties rises above a threshold value for entity real estate properties. The determining may be based on the score of the plurality of real estate properties and the NPV of each of the plurality of real estate properties.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram of a decision model according to the invention;

FIG. 2 is a schematic diagram of apparatus that may be used in accordance with the principles of the invention;

FIG. 3 shows an illustrative schematic diagram according to the invention;

FIG. 4 shows an illustrative system diagram according to the invention;

FIG. 5 shows a schematic diagram according to the invention;

FIG. 6 shows another schematic diagram according to the invention;

FIG. 7 shows a schematic diagram of affinitizing according to the invention; and

FIG. 8 shows a diagram of a study that compares the vacancy rates of a selection of an entity's properties to the coreness of the properties with respect to the entity.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

Real estate assets sold when fully leased can deliver 30%-50% more in sales proceeds than vacant assets. Development of an indicator that evaluates the strategic importance of an asset may influence asset utilization strategies and potentially maximize sales price. An indication of an asset's importance to an entity could also influence the negotiation of various lease provisions, thereby aligning lease structure with entity needs.

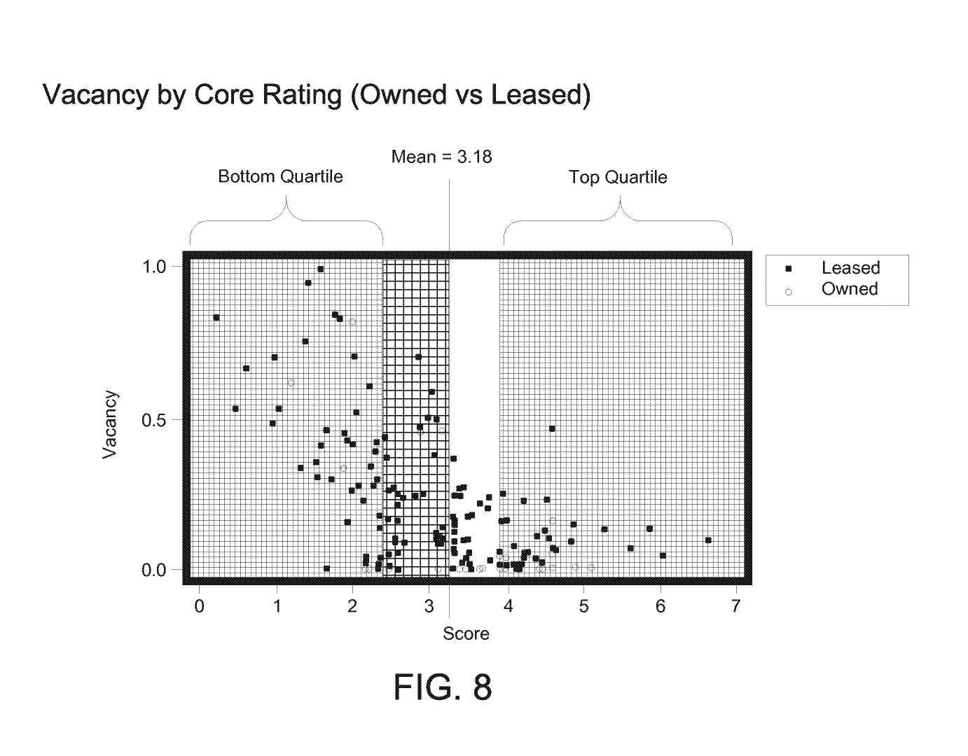

Development of a process according to the invention may include two weighted components: a core property score—i.e., a measure of a real estate property in view of criticality of the property with respect to the functioning of an entity—and a net present value review. The core property score may be based on an analysis to determine the strategic importance of a selected real estate asset(s) based on defined, measurable inputs. The net present value review may be based on an analysis of a term-appropriate net present value (preferably after-tax) cash flow analysis, in the form of a standard “own” versus “lease” model for the selected real estate asset. The process may preferably obtain an index value. Studies have shown that such an index value may correlate with the vacancy rates (past, present and future) of the analyzed property (see FIG. 8 below).

One aspect of the invention relates to providing a set of criteria based on feedback from interested parties, such as feedback obtained through surveys, and limited through constructed decisioning and regression models. Each of a set of criteria identified through the decisioning and modeling may be critical to the quality of the output of systems and methods according to the invention.

Once the data collection process for the feedback is in place, specific variables may be focused on and collected. Thereafter, the data can be processed through a core process valuation model that assigns a specific core property value to a property.

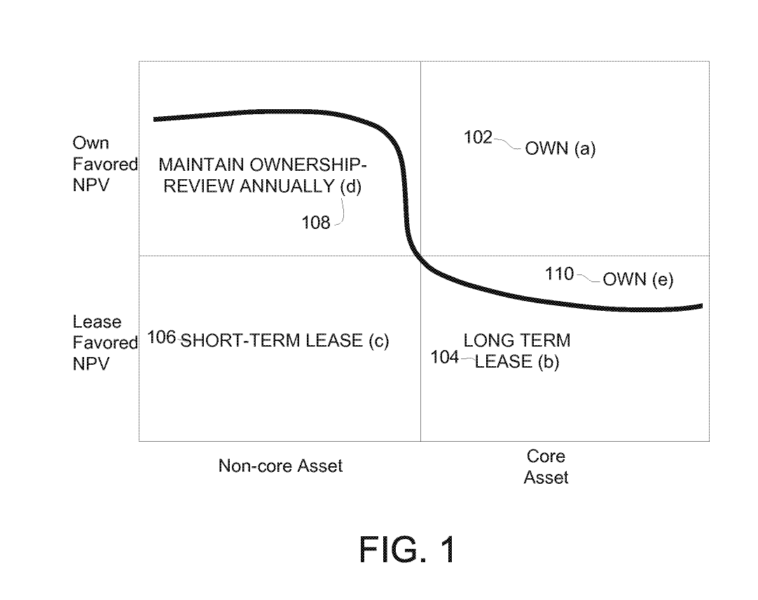

FIG. 1 shows decision model 100. Decision model 100 may categorize the core assets into the following categories: 1) core assets that should be owned if NPV viable, 2) strategic assets that should be owned, independent of NPV viability, 3) core assets that should be leased, long-term, and 4) non-core assets that should only be leased in the short term. The categorization is divided into the following sections as shown in FIG. 1: (a) which represents owned core assets with favorable NPV 102, (b) which represents leased core assets with favorable NPV 104, (c) which represents leased non-core assets with favorable NPV 106, (d) which represents owned non-core assets with favorable NPV 108, (which includes an indication of maintaining ownership while reviewing said ownership annually), and (e) which represents core assets that are currently leased, but may be targets for ownership, with favorable NPV 110, as shown in FIG. 1.

The core property review can be considered the first-phase that identifies potential opportunities, which could be validated in a second phase—e.g., a strategic planning and property appraisals phase.

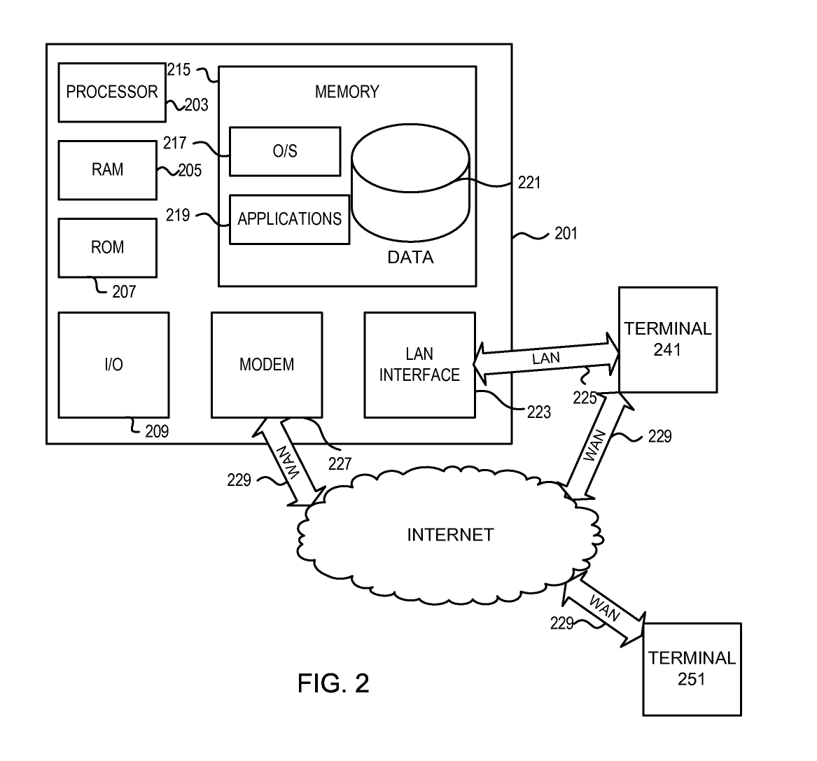

FIG. 2 is a block diagram that illustrates a generic computing device 201 (alternatively referred to herein as a “server”) that may be used according to an illustrative embodiment of the invention. The computer server 201 may have a processor 203 for controlling overall operation of the server and its associated components, including RAM 205, ROM 207, input/output module 209, and memory 225.

Input/output (“I/O”) module 209 may include a microphone, keypad, touch screen, and/or stylus through which a user of device 201 may provide input, and may also include one or more of a speaker for providing audio output and a video display device for providing textual, audiovisual and/or graphical output. Software may be stored within memory 225 and/or storage to provide instructions to processor 203 for enabling server 201 to perform various functions. For example, memory 225 may store software used by server 201, such as an operating system 217, application programs 219, and an associated database 221. Alternatively, some or all of server 202 computer executable instructions may be embodied in hardware or firmware (not shown). As described in detail below, database 221 may provide storage for real estate properties, property data, statistics associated with the real estate properties, and any other suitable information.

Server 201 may operate in a networked environment supporting connections to one or more remote computers, such as terminals 241 and 251. Terminals 241 and 251 may be personal computers or servers that include many or all of the elements described above relative to server 201. The network connections depicted in FIG. 2 include a local area network (LAN) 225 and a wide area network (WAN) 229, but may also include other networks. When used in a LAN networking environment, computer 201 is connected to LAN 225 through a network interface or adapter 223. When used in a WAN networking environment, server 201 may include a modem 227 or other means for establishing communications over WAN 229, such as Internet 231. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 219, which may be used by server 201, may include computer executable instructions for invoking user functionality related to communication, such as email, short message service (SMS), and voice input and speech recognition applications.

Computing device 201 and/or terminals 241 or 251 may also be mobile terminals including various other components, such as a battery, speaker, and antennas (not shown).

A financial institution may use a terminal such as 241 or 251 to utilize a real estate evaluation analysis and platform according to the invention. Applications 219 may include an analysis engine module and/or an evaluation output module stored in memory 225.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

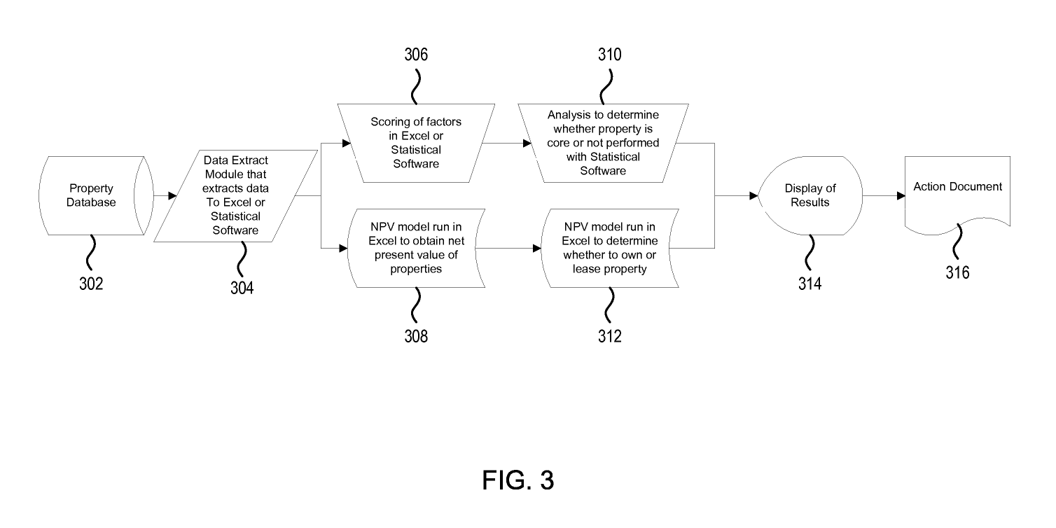

FIGS. 3-8 show illustrative systems and processes. For the sake of illustration, the process will be described as being performed by a system. The system may include one or more of the devices shown in FIG. 2, one or more individuals and/or any other suitable device or approach.

FIG. 3 shows a schematic diagram according to the invention. Property database 302 may include data relating to the properties owned or leased by an enterprise. Such data may be defined and or categorized using predetermined parameters. Such parameters may include selecting either retail or non-retail space, selecting a size threshold for space—e.g., all properties above a certain number of square footage, selecting whether the space to be scored is owned or leased, or any other suitable parameter.

A data extraction module 304 may operate to extract certain relevant data regarding the defined population of properties from database 302 into an Excel TM spreadsheet or other suitable spreadsheet and/or statistical software. Such data may be extracted based on factors identified in responses to survey queries concerning entity needs. Such responses may be adjusted relative to one another. Such an adjustment may be considered a weighting process for each of the factors.

The following queries may be used to determine the relative weight of the factors and, based on the factors, whether to include the property in the set of relevant data. Is the property critical to the entity's operations? Can the property be replicated within the local market? Is the property specialized? Where is the property located? Does the property carry a “symbolic” weight with respect to the entity?

Block 306 shows utilizing the spreadsheet and/or statistical software to select factors that are critical to the quality of the operation. Such factors may be selected by assigning a score to each of the factors based, at least in part, on a compilation of survey results regarding the factors.

Block 308 shows utilizing the spreadsheet and/or statistical software to run a net present value (“NPV”) model to obtain the present value of the properties. Such a model may take into account such factors as vacancy forecasts and inflation. Such a model may also determine using NPV analysis whether it is economically favorable to own or lease the property. Typically, such economic favorability may be weighed against a qualitative importance to entity rating obtained using the relevant data.

Blocks 310 and 312 show performing quantitative analysis with respect to the following two determinations—e.g., is the property core or non-core and whether the entity should own or lease the selected property. The determination of whether the property is core or non-core may be implemented by assigning a weight to each of the selected factors and using the selected factors

Block 314 represents a display of the results obtained in blocks 310 and 312. Block 316 represents an action document—i.e., a document setting forth a suggested course of action with respect to one or more of the properties based on the results of blocks 310 and 312.

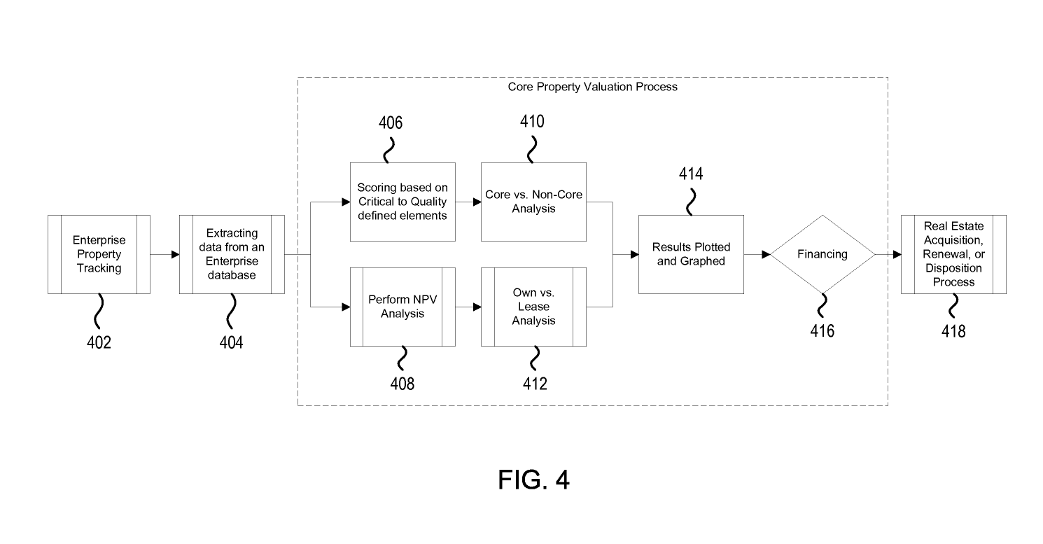

FIG. 4 illustrates a flow diagram for implementing a process according to the invention.

Step 402 may generally refer to the process of tracking the ownership circumstances relating to the various properties owned or leased by an entity. Step 404 shows extracting data relating to the various properties from a database.

Step 404 shows scoring the properties based on preferably predetermined and predefined elements or factors. Such elements may be considered critical-to-quality of the identified properties.

Step 406 shows performing an NPV analysis regarding the value of the properties. Step 412 shows determining, based on the NPV analysis of step 406, whether the entity should purchase or lease the properties.

Step 410 shows using the scoring of step 406 to analyze whether the property is core or non-core to the entity. Step 414 shows plotting the results of steps 410 and 412. Step 416 shows financing 416 the potential purchases and or leases of the properties. Finally, step 418 shows a real estate acquisition, renewal, or disposition process.

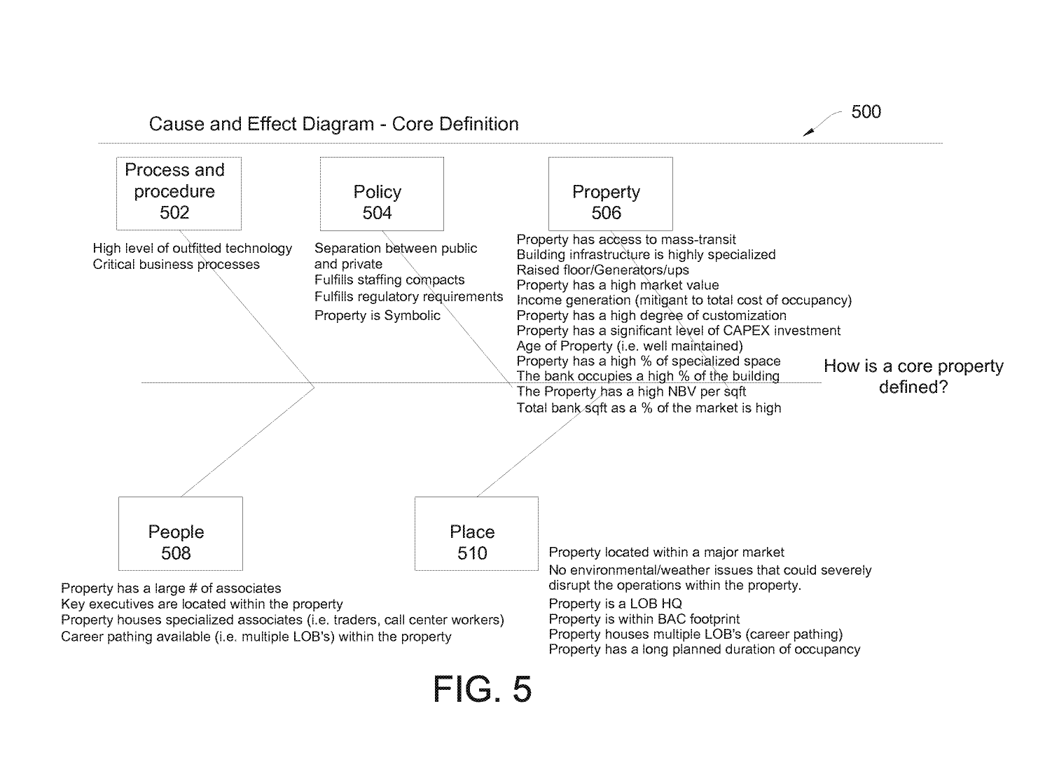

FIGS. 5 shows an illustrative and descriptive diagram 500 of core definitions associated with determining whether a real estate property is a core property to an entity. Such definitions may help to answer the question regarding how the entity defines a core property.

The process and procedure aspects 502 may include determining the level of outfitted technology in the property and the critical business processes. The policy analysis 504 of such properties may include differentiating between public and private property, determining whether the property fulfills staffing compacts, determining whether the property fulfills regulatory requirements, and determining whether the property has symbolic value.

Factors affecting the property 506 may also include whether the property has access to mass-transit; whether the building infrastructure is highly specialized; whether the property has a raised floor, generator, and uninterruptible power supply (“UPS”), and/or whether a property has high market value; whether the property generates income; determining whether the property has a high degree of customization; whether the property has a significant level capital expenditure (“CAPEX”) investment; the age of the property and whether the property is well-maintained; whether the property has percentage of specialized space; whether the entity has high percentage of specialized space; whether the entity occupies a high percentage of the building; whether the property has a high net book value (“NBV”) per square foot; and whether the total entity square footage as a percentage of the market is relatively high.

The determination concerning the people associated with the property 508 may include determining whether the property has a large number of entity associates; determining whether key entity executives are located within the property; whether the property houses specialized associates; and determining whether career pathing (such as multiple entity lines of business (“LOBs”) within the property) is available within the property.

The physical characteristics of the property 510 that may also be evaluated may include determining whether the property is located within a major market; that no environmental/weather issues that could severely disrupt the operations within the property exist; whether the property is an LOB headquarters; whether the property is within an entity locational footprint; whether the property houses multiple LOBs; and the duration of the occupancy of the entity in the building.

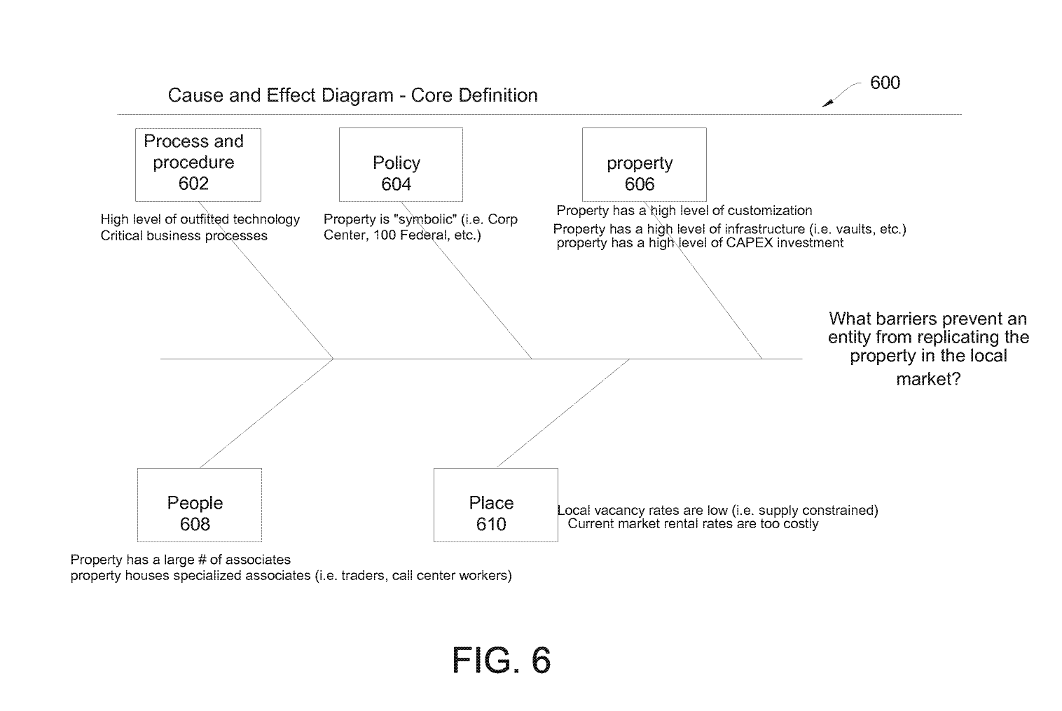

FIG. 6 shows a diagram of what barriers prevent an entity from replicating the property in the local market. Many of the barriers are similar to the issues that help define the core properties. As above, the process and procedure aspects 602 of the barriers include determining the level of outfitted technology in the property and the critical business processes.

The policy analysis 604 of barriers to replicating such properties may relate directly to whether the property is symbolic.

Other factors affecting replicating the property 606 may include determining whether the property has a high level of customization, whether the property has a high level of capital expenditure investment, and the value of the infrastructure—e.g., vaults, etc.

Factors regarding replicating the property that involve personnel 608 include determining whether the property houses a large number of entity associates and whether the property houses specialized associates—e.g., traders, call center workers, etc.

Factors relating to the location of the property that may present a barrier to relocating 610 may include determining whether the current local market rental rates are too costly and whether local vacancy rates are low—i.e., the local market is supply constrained.

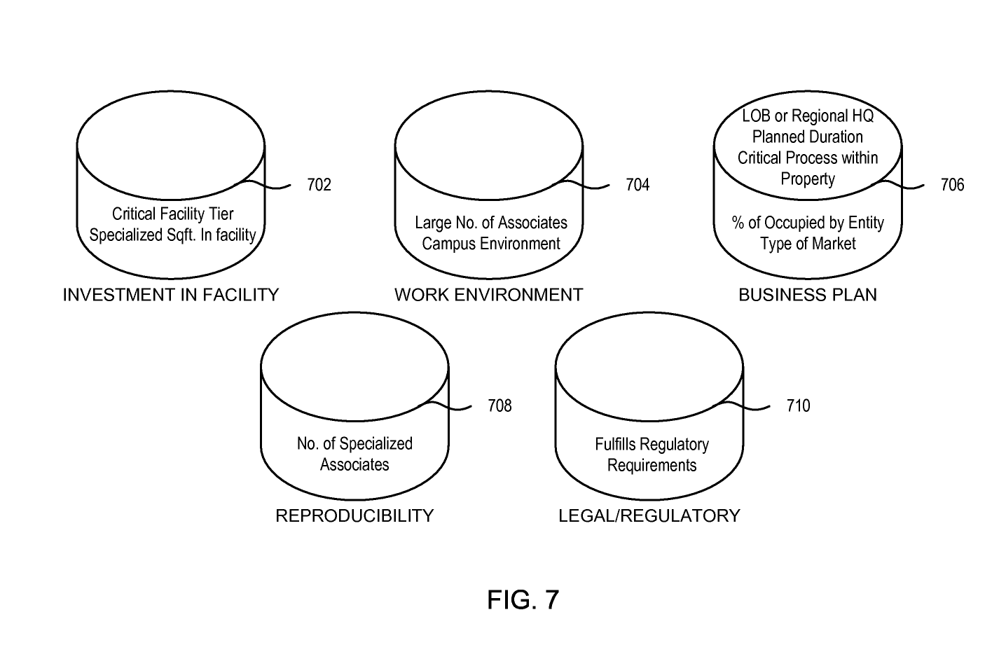

FIG. 7 shows affinitization of the various factors within internal entity categories. Such affinitization may be further used to help define which of the selected properties are core properties to the institution. The factors, including factors set forth above with respect to FIGS. 5 and 6, may be affinitized into categories of factors that affect whether the property should be deemed to be a core property.

An exemplary implementation of the affinitization process may affinitize factors into groups related to the investment in the facility 702, related to the work environment 704, related to the business plan 706, related to the reproducibility of the property at a different location 708, and related to the legal/regulatory issues affecting the property 710.

Each of the factors set forth in FIGS. 5 and 6 may be included in groups 702-710. Nevertheless, a selection of factors is shown in FIG. 7 to illustrate the groupings.

Factors related to the investment in the property 702 may include determining whether the property is a critical facility to the entity. Factors 702 also may include determining whether specialized square footage is found in the property.

Factors 704 relating to the work environment including factors such as the relative number of associates with respect to the total number of associates employed by the entity. Other factors related to the work environment may include determining whether the property is located on a campus environment type space.

Factors 706 may relate to the criticality of the property to the business plan of the entity. Such factors 706 may include whether the property houses a line of business or regional headquarters, what is the planned duration of the entity in the property, and what are the critical processes being implemented at the property. Other factors 706 may include the percent of the facility occupied by the entity and the type of market in which the entity is located.

Factors 708 may include determining the reproducibility of the location in a different location. One factor in determining the reproducibility of the property in a different location may include the number of specialized associates that currently are employed in the present location.

The categories as shown in FIG. 7 may then be weighted, preferably in response to internal entity survey results, to provide a corresponding weight for each of the factors.

Once the categories have been weighted, the weights can be applied to the individual factors, such as the factors set forth in FIGS. 5 and 6. The individual factors may be based on the categories in which the factors are found.

In addition to weighting the factors, other methods may be used to further differentiate each of the factors from one another. For example, survey results may be used to determine the relative importance of each of the factors with respect to one another.

As described above, the factors have been weighted and/or further differentiated from one another. A subset of the total number of the factors can be selected to reduce the statistical analysis computation overhead relating to the determination of which properties are considered core to an entity and which buildings are not considered core to an entity.

Once a subset of factors has been selected, weighted, and differentiated (not necessarily in that order), the subset of factors can be used to evaluate each of a number of entity properties. A property may be scored based on survey results. The survey preferably identifies how each property scores on the selected subset of factors.

Thus, methods of determining the importance of the property to the entity have been provided. Together with the NPV analyses set forth in FIG. 1, systems and methods according to the invention may preferably help determine a future course of action for the property entities.

FIG. 8 shows one possible diagram 800 of a study that compares the vacancy rates of a selection of an entity's properties to the coreness of the properties with respect to the entity. Diagram 800 indicates a correlation between the vacancy and the coreness of the property.

The x-axis in FIG. 8 indicates the relative coreness of the property. The higher the relative coreness of the property, the more important the property is to the entity. The mean score of “coreness” is shown at 3.18.

It can be seen from the diagram that higher-scoring properties typically have a lower vacancy rating than the lower-scoring properties. Accordingly, systems and methods according to the invention may be used to determine the coreness of the properties. It has been shown that such a coreness indication correlates with the vacancy rates of the properties. The correlation may, in certain embodiments of the invention, be expressed as a correlation between the four quartiles shown in FIG. 8 and the areas 102-110 shown in FIG. 1.

Aspects of the invention have been described in terms of illustrative embodiments thereof. A person having ordinary skill in the art will appreciate that numerous additional embodiments, modifications, and variations may exist that remain within the scope and spirit of the invention.

One of ordinary skill in the art will appreciate that the apparatus features described herein and illustrated in the FIGS. may be arranged in other than the recited configuration and that one or more of the features may be optional. Also, the methods described herein and illustrated in the FIGS. may be performed in other than the recited order and that one or more steps illustrated may be optional. The above-referenced embodiments may involve the use of other additional elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems and methods for providing core property review have been provided. Persons skilled in the art will appreciate that the present invention can be practiced by other than the described embodiments, which are presented for purposes of illustration rather than of limitation, and that the present invention is limited only by the claims that follow.

What is claimed is:

1. A method for reviewing a plurality of real estate properties, said plurality of real estate properties either owned in whole or in part or leased in whole or in a part by a single entity, the method comprising:
extracting data from a database, said data corresponding to the plurality of real estate properties;
using the data to score each of the plurality of real estate properties;
using a spreadsheet to perform a Net Present Value (“NPV”) analysis for each of the plurality of real estate properties; and
determining whether each of the plurality of real estate properties rises above a threshold value for entity real estate properties, said determining being based on the score of each of the plurality of real estate properties and the NPV of each of the plurality of real estate properties.

2. The method of claim 1 further comprising providing a course of action with respect the plurality of real estate properties, said course of action based on whether each of the plurality of real estate properties is above the threshold value.

3. The method of claim 1 wherein the scoring comprises scoring based on an analysis of at least two elements selected from the group of 1) amount of specialized space located within the property, 2) the amount of space in the property that is entity-occupied, 3) the entity occupancy forecast, 4) whether the entity uses the property for a regional headquarters or for a division headquarters, 5) whether the property fulfills regulatory requirements, and 6) the market type of the property.

4. The method of claim 1 further comprising comparing results of the determining to the vacancy rates in the properties.

5. The method of claim 1, the extracting comprising extracting based on a set of predetermined parameters.

6. The method of claim 5, the predetermined set of parameters comprising at least one of 1) whether the property is retail or non-retail space, 2) whether the property exceeds a predetermined number of square feet, and 3) whether the property is owned or leased.

7. A computer-readable medium storing computer-executable instructions which, when executed by a processor on a computer system, perform a method for providing core property review, the method comprising:
calculating a score for each of a plurality of real estate properties related to a single entity, said calculating being based on an analysis of predetermined elements;
performing a Net Present Value (“NPV”) analysis for each of the plurality of real estate properties; and
determining whether an index value for each of the properties based on the score and the NPV for each of the plurality of real estate properties rises above a threshold value.

8. The computer-readable medium of claim 7 wherein the scoring based on an analysis of predetermined elements comprised scoring based on at least two elements selected from the group of: an amount of specialized space located within the property, an amount of space in the property that is entity-occupied, an entity occupancy forecast, whether the entity uses the property for a regional headquarters or for a division headquarters, whether the property fulfills regulatory requirements, and a market type of the property.

9. An apparatus for providing real estate property review and evaluation, the apparatus comprising:
a storage module;
an analysis engine in communication with the storage module; and
an evaluation output module in communication with the analysis engine;
wherein the analysis engine is configured to:
receive from the storage module information corresponding to a plurality of real estate properties, the information further corresponding to a predetermined group of data points for each of the properties;
calculate a score for each of the properties based on the information for the data points for each of the properties; and
transmit to the evaluation output module an index value for each of the properties based, at least in part, on the calculated score for each of the properties.

10. The apparatus of claim 9 wherein the index value is also based on the net present value for each of the properties.

11. The apparatus of claim 1 wherein the evaluation output module is configured to provide a course of action with respect the plurality of real estate properties, said course of action based on whether the index value is above the threshold value.

12. The apparatus of claim 10 wherein the calculating the score based on an analysis of predetermined elements comprises calculating the score based on at least two elements selected from the group of amount of specialized space located within the property, the amount of space in the property that is entity-occupied, the entity occupancy forecast, whether the entity uses the property for a regional headquarters or for a division headquarters, whether the property fulfills regulatory requirements, and the market type of the property.

13. The apparatus of claim 10, wherein the analysis engine is further configured to compare the results of the determining to the vacancy rates in the properties.

14. The apparatus of claim 10 further comprising a data extraction module for retrieving information from the storage module and transmitting the information to the evaluation output module, the information being based on a predetermined set of parameters.

15. The apparatus of claim 14, the predetermined set of parameters comprising at least one of 1) whether the property is retail or non-retail space, 2) whether the property exceeds a predetermined number of square feet, and 3) whether the property is owned or leased.
